(19) United States
(12) Patent Application Publication
(10) Pub. No.: US 2004/0239671 A1
(43) Pub. Date: Dec. 2, 2004

(54) Calculating the distance between graphical objects

(76) Inventor: Marc Vollenweider, Regensdorf (CH)

Correspondence Address: William H Logsdon, 700 Koppers Building, 436 Seventh Avenue, Pittsburgh, PA, 15219-1818, US

(21) Appl. No.: 10/480,673

(22) PCT Filed: Jun. 12, 2001
(86) PCT No.: PCT/CH01/00364

(51) Int. Cl. G06T 15/40; G06T 15/00

(52) U.S. Cl. 345/421; 345/419

(57) ABSTRACT

A method and representation system for graphical objects for fast calculation of interactions between said graphical objects being defined through a first closed geometrical curve is provided. Every object is represented through at least two nodes and neighboring nodes are connected through a skeleton line. A bounding object is attributed to every node defining sections in the neighborhood of every node wherein said sections forming a second closed geometrical curve being entirely inside or entirely outside of said first closed geometrical curve. A mean distance of a boundary object from a skeleton line or two points on the said skeleton line of both graphical objects in direction of the connection line of the minimum distance between said skeleton lines is calculated. A comparison is made between the sum of values for both graphical objects on the connection line of the distance and said distance to device.

The invention relates to a system and method of image generation for graphical objects, especially to volume graphics and to a discrete object representation for at least two objects that allows accurate and fast calculations of interactions between said two graphical objects.

Within the prior art there are a multitude of approaches for the image generation for graphical objects, especially 3D-objects.

U.S. Pat. No. 6,195,625 describes a method for simulating collisions of 3D-objects. Within this context the method of finite elements is mentioned which is one approach necessitating great calculation power.

U.S. Pat. No. 6,131,097 discloses a method for authoring geometrical data-bases, especially in view of interactions between objects, wherein stiffness, friction and other properties of the objects and their surfaces may be incorporated. The approach used by U.S. Pat. No. 6,131,097 are bounding boxes, to rule out distant objects. In a 3D-world this is a rather complicated approach when there are a multitude of objects and especially complicated objects.

U.S. Pat. No. 6,040,835 describes a polygonal surface model to calculate the distance from a given point to said surface.

Based on the prior art the object of the invention is to provide a faster method to calculate the representation of graphical objects, especially in view of possible collisions between said objects.

For a method this object of the invention is achieved through the features of claim 1. For a system the features of claim 4 solve the underlying problem of the invention.

The method and representation system for graphical objects for fast calculation of interactions between said graphical objects is based on graphical objects being defined through a first closed or open geometrical curve. Every object is represented through at least two nodes and neighboring nodes are connected through a skeleton line. A bounding object is attributed to every node defining sections in the neighborhood of every node wherein said sections forming a second closed or open geometrical curve being entirely or partially inside or entirely or partially outside. Then the mean distance of a boundary object from a skeleton line of both graphical objects in direction of the connection line of the distance between said skeleton lines or two points on the said skeleton line is calculated and the comparison is made between the sum of that values for both graphical objects on the connection line of the distance and said distance to decide if a collision may happen.

It will be appreciated that the method is usable for the interaction between two 3D-objects and also between 3D- and 2D-objects and between two 2D-objects. Since the calculation reduces the calculation of boundary objects in a first step and surface objects in a second step to a one-dimensional or two-dimensional problem in each case the biggest reduction in calculation efforts can be found when two 3D-objects are in space.

These and other features of the invention will be better understood in relation of the detailed description in conjunction with the drawings, of which:

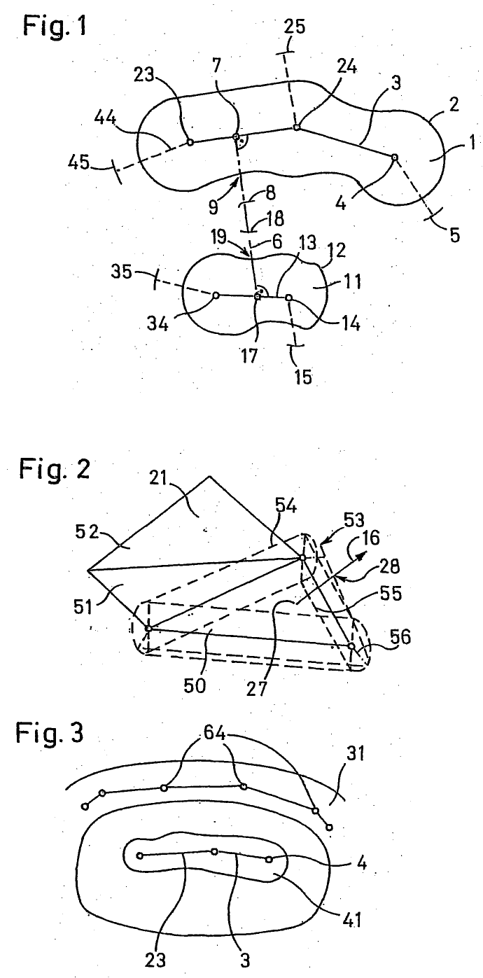

FIG. 1 shows a schematically cross-sectional view of two 3D-objects one beside another,

FIG. 2 shows a schematically perspective view of a 2D-object with its boundary object,

FIG. 3 shows a schematically cross-sectional view of two 3D-objects, one object inside a hollow second object,

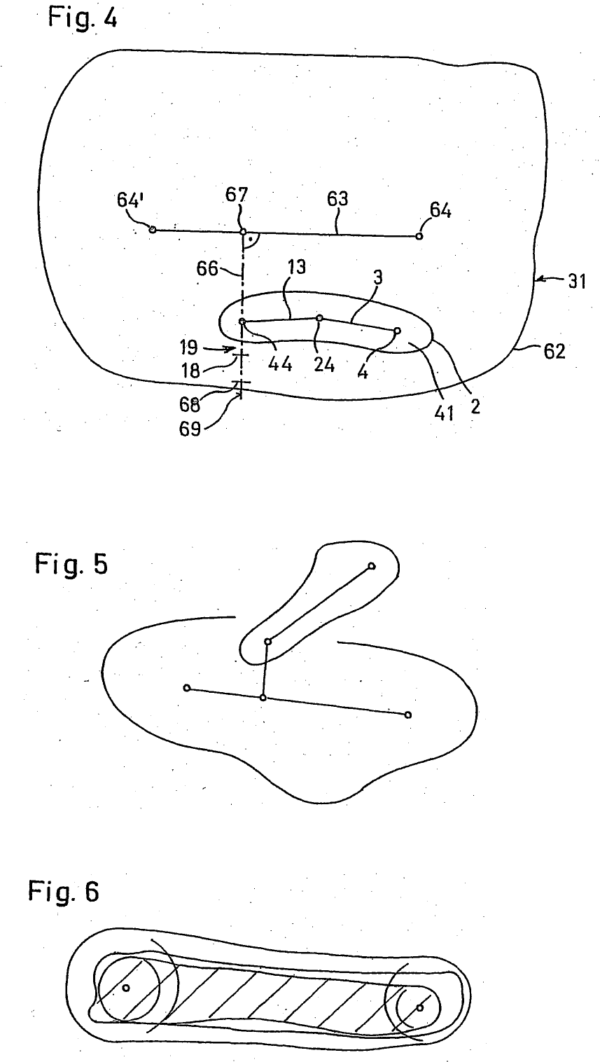

FIG. 4 shows a schematically cross-sectional view of the two 3D-objects of FIG. 3 using a different approach to reduce the number of necessary skeleton objects,

FIG. 5 shows a schematically cross-sectional view of two object, where one object has been cut open,

FIG. 6 shows a schematic view of a simple shaped object (e.g. tube) where the boundary bodies are used inside and outside to allow a fast and realistic collision as the intersection with the surface has not to be calculated,

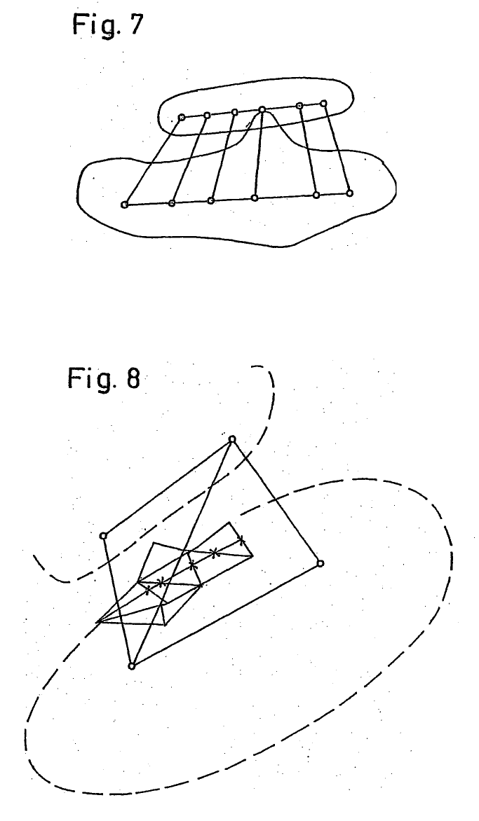

FIG. 7 illustrates an approach with two arbitrary points on segments, wherein two intersections are tested to find the critical point on the surface, and

FIG. 8 illustrates a continuos search starting from an intersection on at surface until the critical point is found, which enables a fast calculation with neighborhood functions.

FIG. 1 shows a simple body 1 having an outer surface 2 and a line skeleton 3 and 23, connecting three nodes 4, 24 and 44. For simplicity, the drawing shows a 2D representation so that the surface 2 is a line (in the plane of representation). The three nodes 4, 24 and 44 are also all in the same plane. The method of the invention can be applied to such 2D representations. However, the method is very well suited for applications within a real 3D-environment. The representation of FIG. 1 can then be seen as the cross-section through the plane encompassing the skeleton lines 3, 23. In a more complicated case, no two skeleton lines 3, 23 are in the same plane and there are multitude of said nodes in different planes.

FIG. 1 further shows a second simple body 11 having an outer surface 12 and a—one—skeleton line 13, connecting two nodes 14 and 34. It is noted that the two nodes 14, 34 are below and above the plane of body 11. Therefore only one point of the skeleton line 13 is in the same plane as skeleton lines 3 and 23 of first body 1.

Around every node 4, 24, 44 and 14, 34 of all bodies 1, 11 is provided a bounding body 5, 25, 45 and 15, 35, respectively. For simplicity reasons the bodies are supposed to be spheres and only a radius is shown and receives the reference. Besides spheres it is possible to use cubes or every other 3D body as bounding body, so long as defined segments of the surfaces of the bounding body encompass portions of the real surface 2, 12 of the objects 1, 11.

The method according to the invention then calculates the distance between all skeleton lines or two points on the skeleton lines 3, 23 of one body with every skeleton line 12 of another (every other) body 11. This calculation creates a point 7 on skeleton line 23 between nodes 24 and 44. Point 7 divides the length of skeleton line 23 in two portions X₂₄ and X₄₄, wherein X₂₄+X₄₄ equals to the distance between the two nodes 24 and 44.

The embodiment according to FIG. 1 uses spheres 25 and 45 as bounding bodies around nodes 24 and 44 with radii R₂₅ and R₄₅. Then the relevant distance between the two skeleton lines or two points on the skeleton lines 23 and 13 (i.e. the distance D₇₋₁₇ in space between points 7 and 17 can be found as the sum of two distances calculated for every body 1 and 11, respectively. These distances D₁ and D₁₁, in the drawings schematically shown as 8 and 18., respectively, can be calculated from:

D₁=(X₂₄*R₄₅+X₄₄*R₂₅)/(X₂₄+X₄₄)

D₁₁=(X₁₄*R₃₅+X₃₄*R₁₅)/(X₁₄+X₃₄)

It can be seen that in the case that the distance is in one node, e.g. node 44, than X₄₄=0 and D₁=R₄₅, e.g. the corresponding distance value from the bounding box around node 44.

If said distance between points 7 and 17, D₇₋₁₇, is greater than D₁+D₁₁, then this part of bodies 1 and 11 is not colliding and the next calculation can be performed, i.e. between the skeleton lines 3 and 13 of bodies 1 and 11.

It has to be noted that, when the bounding box is a complex structure, the relevant value R₂₅ or R₄₅ and R₁₅ or R₃₅ are scalar values which may be obtained from a matrix governing the form of the corresponding bounding box and these values may behave non continuous for different neighboring points on skeleton line 13 or 23.

If the above mentioned distance is smaller than the calculated sum than a second step of the method is performed for objects where the boundary boxes are not sufficient. For simple shaped objects (e.g. tubes) an inner boundary object can be defined for the whole object or parts of the object to avoid the second step. The model of the graphical representation of the bodies 1 and 11 encompass surface elements 2 and 12. Although the second step has not to be performed for the position of the bodies 1 and 11 in FIG. 1 the principle can be effectively demonstrated. The second method step provides the calculation of the points 9 and 19 within the surface 2 and 12, respectively, being on the line 6 of the shortest distance in distances D₇₋₉ and D₁₇₋₁₉ from points 7 and 17, respectively. Only in the case that D₇₋₁₉+D₁₇₋₁₉ is greater than D₇₋₁₇ a collision has occurred and some supplemental action has to be taken, depending on the kind of elements colliding (stiffness, sharpness, etc . . . ).

This method effectively reduces the calculations of distances between a multitude of more or less complex 3D bounding boxes through a first test necessitating only a scalar calculation and comparison for distances between two points in space, and, only if this proves successful (i.e. collision possible), a second test has to be performed calculating the distances between two further points which are easily derived on the basis of the first test. Therefore two complex 3D-calculations are replaced by two simpler 1D-calculations. The embodiment shown in FIG. 1 relates to global movement.

It is furthermore possible to use the method for local deformations.

In the case of collision, it is possible to use one or both intermediate points 7 and 17 as new nodes and restarting the calculations of the method with the skeleton line 23 being replaced through two skeleton lines (between node 44 and new node 7, and new node 7 and node 24), enabling that one part of one body is gliding and pivoting, e.g. falling, around the other body.

It is also possible to define that one surface, e.g. all points 19 within body 11, is stiff and is not to be deformed. This can be used within representation of medical procedures for scissors or an endoscope etc. Within simulation of impact of an object (e.g. a stone) into a car this may be used for such an object as a stone. Then, within the global picture, the relevant nodes 24 and 44 or 14 and 34 are displaced.

A body can also be defined as flexible. This-can be used for an organ represented within medical procedures or above mentioned car hurt by a stone. Then the point 9 or 19 is able to be “pushed” in direction of line 6 towards the skeleton line 23 or 13 without moving the inner skeleton nodes 24 and 44 or 14 and 34. This can be governed through a resistance factor growing with reduced distance to the skeleton line 23 or 13. This simple procedure has the advantage that the direction of deformation is always correct, i.e. in the direction of the impact, e.g. the shortest distance between points of the skeleton links.

FIG. 2 shows schematically the use of the method within a 2D-object 21. Such an object 21 may be a cloth covering a 3D-body within a graphical representation or a hernia net within surgical representations, interacting with another 2D-object or a 3D-object as an endoscopic instrument to virtually place such a 2D-surface. Usually 2D-objects 21 are demonstrated through triangles 50, 51 and 52. However, also other geometrical forms of representations are possible as different polygons. Triangle 50 comprises a 3D-environment 53 having an upper 3D-part 54, a lower 3D-part 55 and a sideways extending part 56. This is just another more complicated bounding body than the spheres of FIG. 1. Here it is possible to define the distance of the surface 50 of 2D-body 21 to another body, either another surface or a skeleton line. This shortest distance 16 is represented through an arrow starting from a point 27. As in the method described within FIG. 1 the intersection point 28 of the bounding body 53 with the shortest distance line 16 is calculated and only in the case that the sum of the distance from point 27 to intersection point 28, i.e. D₂₇₋₂₈, and e.g. D₁₁ is smaller than the length of line 16 the second step is entered wherein the surface structure, i.e. line structure, of the bodies 21 and 1 or 11 is calculated, to decide, if collision occurs.

FIG. 3 shows a partly very schematically representation of the application of the method according to FIGS. 1 and 2 to the graphical representation of an body 31 inside another body 41 or a hollow body 41 having a second body 31 inside. A typical situation for the need of such a representation for the first mentioned category is an object within an organ and the second mentioned category relates to an body opening 31 of a human or an animal as the esophagus or the colon or the interior of a hollow organ as the stomach, wherein the second body 41 is an endoscope or a foreign object. As can be seen from FIG. 3 hollow body 31 than necessitates an important number of nodes 64 which gives rise to an important number of skeleton lines to be compared against the lines 3 and 23 of body 41. The number of calculations according to the method of the invention can be reduced significantly using a slightly different method shown in FIG. 4. The difference is that the nodes 64 for the body 31 are positioned inside the hollow space and therefore the first category (object within an object) is now treated in an identical way then the second category (object within hollow object).

In order to evaluate the risk of collision between objects 31 and 41 it is not the shortest distance between skeleton lines 13 and 63 but the greatest “shortest distance” between points on the skeleton line 13 of the smaller body 41 and the skeleton line 63 of the hollow body 31 (or bigger body). Said distance can always be found as the normal from the end nodes 24 or 44 of the skeleton line 13 towards the skeleton line 63. Then the distance 18 from point 44 in the direction away from skeleton line 63 is calculated as in the embodiment described in connection with FIG. 1. In view of body 31 the bounding body is an inner bounding body with two parameters for point 67 on skeleton line 63.

With X₆₄ as distance between points 64 and 67 and X_{64′} as distance between points 64′ and 67, and R₆₄ as bounding body value for point 64 and R_{64′} as bounding body value for point 64′ the distance for body 31, shown as reference 68 is calculated as:

D₃₁=(X₆₄*R_{64′}+X_{34′}*R₆₄)/(X₆₄+X_{64′})

Then a collision of the inner body 41 with the hollow body 31 (equivalent to the exit of body 41 out of body 31) is to be tested when D₃₁ is smaller than the sum of distance between points 67 and 44 D₆₇₋₄₄ and D₁. In this case the second calculation for points 19 and 69 has to be performed as in the first embodiment along and using the line 66.

It has to be noted that, although all embodiments are showing two distinct bodies, it is possible that the calculation has to be performed between different sections of the same body in case that said body is so flexible that two sections of it may interact. An example for such a case of one-body-interaction is the graphical representation of the small intestine. Therefore the wording two graphical objects has also the meaning two parts or sections of one body spaced apart within one body.

It is clear that the method according to the invention can be modified through a number of parameters without leaving the scope of protection defined through the enclosed claims.

1-5. (cancelled)

6. A method of image generation for graphical objects for fast calculation of interactions between a first and second graphical object, wherein said first and second graphical objects are defined by a respective first closed or a first open geometrical curve wherein said first and second graphical object is each represented by at least one node, wherein neighboring nodes are connected by a skeleton line, wherein a bounding object is attributed to every node, whereby sections are defined in a neighborhood of every node, wherein said sections form a second closed or a second open geometrical curve, wherein the second closed or the second open geometrical curve is entirely inside or partially inside or entirely or partially outside of said first closed geometrical curve, said method comprising the steps of:
a) when the second closed or the second open geometrical curve is outside of said first closed or said first open geometrical curve for both graphical objects:
a1) calculating a distance between two skeleton lines, two points on said skeleton lines, or nodes of the skeleton of said first and second graphical objects, creating a point on each skeleton line between the corresponding nodes, dividing the length of each skeleton line into two portions;
a2) calculating a dimension of the bounding object in direction of a connection line of the distance for every node;
a3) calculating a dimension of the bounding object in direction of a connection line at said point for every object as proportional to the relative distance of said point to the neighboring nodes;
a4) comparing a sum of said dimension of the bounding objects of each of said first and second graphical objects with said distance; and
a5) when said distance is greater than said sum of said dimensions of the bounding objects, acknowledging that a portion of each of said first and second graphical objects is not colliding, and restarting at step a1) with other skeleton lines, and performing a further collision step when said distance is smaller or equal to said sum; and
b) when the second closed or the second open geometrical curve is inside of said first closed or said first open geometrical curve for a first graphical object:
b1) calculating a distance between a skeleton line, points on the skeleton line, or nodes of the skeleton line of said first graphical object and a node of said second graphical object, creating a point on the skeleton line between the corresponding nodes, dividing the length of each skeleton line into two portions;
b2) calculating a dimension of the bounding object in direction of a connection line of a distance for every node;
b3) calculating a dimension of the bounding object in direction of said connection at said point of said first graphical object as proportional to the relative distance of said point to the neighboring nodes;
b4) comparing a sum of said distance plus the dimension of the bounding object for the node of said second graphical object with the dimension of the bounding object of said first graphical object, and
b5) when said sum is smaller than the dimension of the bounding object of said first graphical object, acknowledging that a portion of each of said first and second graphical objects is not colliding, and restarting at step b1) with other skeleton lines and nodes, and performing a further collision step when said sum is greater than the dimension of the bounding object of said first graphical object.

7. The method according to claim 6, wherein said first and second graphical objects are 2D or 3D objects and wherein said geometrical curves are one of surfaces and lines.

8. The method according to claim 6, wherein the further collision detecting step comprises the step of calculating the intersection point of said geometrical curves of said first and second graphical objects on the line of the distance, whereas it is assumed that a collision has occurred if the sum of the distances between said intersection points and the relating point on the skeleton line or node is greater than the distance between the relating points on the skeleton line or node.

9. A representation system for graphical objects for fast calculation of interactions between said graphical objects, wherein said graphical objects are defined by a first closed or a first open geometrical curve, wherein every object is represented by at least one node, wherein neighboring nodes are connected through a skeleton line, wherein a bounding object is attributed to every node, whereby sections are defined in the a neighborhood of every node, wherein said sections from a second closed geometrical curve inside or outside of said first closed geometrical curve, with means for calculating a mean distance of a boundary object from a skeleton line of both graphical objects in direction of the connection line of the distance between said skeleton lines or two points on the said skeleton line and for making a comparison between a sum of values for both graphical objects on the connection line of the distance and said relevant distance.

10. The system according to claim 9, further comprising means performing a further collision detecting step, wherein the detecting step includes:
a) calculating an intersection point of said geometrical curves of said geometrical curves of said graphical objects on a line of the shortest distance, and
b) determining that a collision has occurred if the sum of the distances between said intersection points and the relating point on the skeleton line or node is greater than the distance between the relating points on the skeleton line or node.
